(19) United States
(12) Patent Application Publication
(10) Pub. No.: US 2005/0170058 A1
(43) Pub. Date: Aug. 4, 2005

(54) Jelly food containing soybean 7s-protein

(76) Inventors: Toshimitsu Baba, Izumisano-shi (JP); Mitsuka Kohno, Izumisano-shi (JP); Motohiko Hirotsuka, Izumisano-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/509,594

(22) PCT Filed: Apr. 3, 2003
(86) PCT No.: PCT/JP03/04248

(30) Foreign Application Priority Data
Apr. 3, 2002 (JP) 2002-101105

(51) Int. Cl. A23L 1/05

(52) U.S. Cl. 426/573

(57) ABSTRACT

A jelly food containing soybean protein that even when a soybean protein is contained, realizes high storage stability, exhibits low probability of deposition at a weak acid zone and ensures excellent flavor. In particular, jelly food wherein use is made of low phytic acid soybean 7S-protein. More particularly, a jelly food containing soybean 7S-protein wherein the phytic acid content is 0.2% or less, preferably 0.1% or less, per protein.

### TECHNICAL FIELD

The present invention relates to jelly food comprising soybean 7S protein.

### BACKGROUND ART

Soybean protein has physiological functions for normalizing a serum cholesterol level, decreasing serum lipid concentration, etc., and has been known to be a food material having a high nutritional value with a good balance of essential amino acids. Accordingly, many processed foods in the form of desserts utilizing soybean protein have been developed in recent years.

However, the production of acidic jellies mainly comprising protein separated from soybeans involves problems that a satisfactory product is hardly obtainable because soybeans have peculiar unpleasant odor and taste, and further protein tends to be coagulated and precipitated under acidic conditions.

Many processes for fractionating soybean 7S protein from soybean protein as one of constituent components thereof have been proposed in the past years. For example, Wolf et al., Thanh et al., and Nagano et al, have been studied and reported laboratory fractionation methods, and Wo et al. have developed a plant level process (JAOCS, Vol. 76. No. 3, p 285-293, 1999) based on the above method of Nagano et al. (J. Agric. Food Chem., Vol. 40, 9941-944, 1992). In addition, there are many processes including JP 48-56843 A, JP 49-31843 A, JP 51-86149 A, JP 55-124457 A, JP 55-153562 A, JP 56-64755 A, JP 57-132844 A, JP 58-36345 A, JP 61-187755 A, etc.

The object of the present invention is to obtain jelly food comprising soybean protein which has high storage stability and hardly forms a precipitate in a weakly acidic region, and is excellent in a flavor, even when it contains soybean protein.

### DISCLOSURE OF THE INVENTION

The present inventors have studied intensively so as to achieve the above object and, as a result, obtained the following findings.

(1) Soybean 7S protein can be fractionated in purity of not less than 60% after removing 11S protein from defatted soybeans by the method of Thanh and Shibasaki that is a general fractionation method of soybean protein components.

(2) When solubility of soybean 11S protein purified at the same time of the above purification of soybean 7S protein, and solubility of proteins prepared by decomposing and removing phytic acid combined to soybean 7S and 11S proteins were measured at various pH using conventional isolated soybean protein as a reference. It was found that only soybean 7S protein having a low-phytic acid content as a result of decomposition and removal of phytic acid had improved solubility at a weakly acidic region of about pH 4.0.

(3) Low-phytic acid content soybean 7S protein, wherein phytic acid has been decomposed and removed, can be fractionated by further treating soybean protein with a phytic acid decomposition enzyme.

Then, the present inventors have found that low-phytic acid soybean 7S protein obtained by decomposition and removal of phytic acid from fractionated and purified soybean 7S protein, or low-phytic acid soybean 7S protein obtained by treating soybean protein with a phytic acid decomposition enzyme can be utilized as a protein source having high solubility in a weakly acidic region. Thus, the present invention has been completed.

That is, the present invention provides:

(1) Jelly food using low-phytic acid soybean 7S protein;

(2) The jelly food comprising soybean 7S protein according to (1), wherein the phytic acid content is containing 0.2% or less of phytic acid relative to the protein;

(3) The jelly food comprising soybean 7S protein according to (1) or (2), which is in a weakly acidic region; and

(4) The jelly food comprising soybean 7S protein according to any one of (1) to (3), wherein 10% by weight or less of soybean 7S protein is used.

### BRIEF DESCRIPTION OF THE DRAWINGS

FIG. 1 illustrates solubility characteristics of low-phytic acid soybean 7S protein, soybean 7S protein and conventional isolated soybean protein.

FIG. 2 illustrates solubility characteristics of low-phytic acid soybean 11S protein, soybean 11S protein and conventional isolated soybean protein.

### BEST MODE FOR CARRYING OUT THE INVENTION

“Soybean 7S globulin” as used herein refers to, among globulins which are a general name of soluble globular proteins, globulin having molecular weight corresponding to 7S of an ultracentrifuge sedimentation coefficient. Globulins are divided into 2S, 7S, 11S and 15S fractions depending upon the molecular weight distribution thereof, and 7S and 11S fractions have been known to account for a large proportion in storage protein of a legume such as soybeans.

In the present invention, soybean 7S protein refers to a fraction having a high content of soybean 7S globulin fractionated from soybean protein. In order to increase the content of soybean 7S globulin, first, a 11S globulin-rich fraction is removed. For removing such a fraction, in addition to the above-mentioned method by Wo et al., there may be employed any one of fractionation methods which are widely used today for fractionation of each globulin component, including the method by Thanh and Shibasaki (Thanh, V. H. and Shibasaki, K. J., Agric. Food Chem., 24, 117, 1976) as well as a cold-insoluble fraction method (called as CIF). by so-called cryogenic precipitation (Briggs, D. R. and Mann, R. L., Cereal Chem., 27, 243, 1950), the fractionation method by addition of 0.1 N calcium chloride described by Wolf et al. (Wolf, W. J. and Sly, D. A., Cereal Chem., 44, 653, 1967), and the like. Further, soybean protein separated from soybeans containing about 50% or more of soybean 7S protein in the seeds developed by a breeding technology may also be used (Breeding Science, 50.10.1.2000). After removing 11S globulin by any one of the above methods, soybean 7S protein is formed into curd and fractionated according to a conventional process for preparing isolated soybean protein. At this time, soybean 7S protein having sufficient purity for use can be fractionated without using a reducing agent. Further, since protein containing no reducing agent is expected to have a wider field of application, even when it is used for soybean protein-containing jelly food. Further solubility in a weakly acidic region such as pH 3 to 4.3 can be improved by reacting the soybean 7S protein fraction thus obtained with an enzyme such as phytase or phosphatase or an enzyme preparation having a phytic acid decomposition activity to decompose and remove phytic acid. As a method for fractionating low-phytic acid soybean 7S protein in which phytic acid is decomposed and removed, it is possible to remove 11S globulin simultaneously by directly reacting soybeans with an enzyme such as phytase and phosphatase or its enzyme reagent having a phytic acid decomposition activity to act to soybean protein directly.

Desirably, the soybean protein used in the present invention is soybean 7S protein containing not less than 60%, preferably not less than 70%, more preferably not less than 85% of soybean 7S globulin based on the total globulins therein.

Desirably, the jelly food contains 1 to 10%, preferably not more than 5% of low-phytic acid soybean 7S protein. When the content of low-phytic acid 7S protein exceeds 10%, viscosity of the jelly food increases, and the resulting texture becomes crumbly. This is undesirable.

When pH is too low, the resulting jelly food has too sour taste and becomes hardly edible. On the other hand, when the pH is too high, storability is deteriorated. Therefore, desirably, the pH of the jelly food is 3.0 to 4.3, preferably 3.5 to 4.0.

The jelly food of the present invention is not limited to gelled food having no fluidity such as that mainly served for dessert, and includes such type of food that is gelled to an extent not impairing fluidity thereof and packed in a flexible container (called as a Cheer pack, etc) and, upon eating, is squeezed out of the container or is fluidized by shaking the gel in the container.

The gelling agent used for the jelly food is not specifically limited so long as it can form a gel without reacting with soybean 7S protein, and examples thereof include agar, gelatin, etc.

For producing the jelly food of the present invention, in order to enhancing its taste, known raw materials such as other proteins, oils and fats, saccharides, water, flavors, seasonings, and the like can be added in addition to sugar and fruit juices. The jelly food of the present invention can be produced by a known method by, for example, blending required amounts of these materials, followed by homogenization and sterilization.

Water soluble soybean polysaccharide and high methoxy pectin alone or in combination thereof can also be used for dispersing protein, thereby reducing rough mouthfeel.

The following Examples illustrate the advantages of the preset invention, but are not to be construed to limit the technical idea of the present invention.

### PRODUCTION EXAMPLE 1

Preparation of Low-Phytic Acid Soybean 7S Protein (1)

Water was added to defatted soybeans in a weight ratio of 1 (soybeans): 10 (water), and the mixture was stirred for 1 hour while the pH was occasionally adjusted to 7.0. The mixture was centrifuged (4,000 rpm, 20° C., 10 minutes), and the supernatant obtained was adjusted to pH, 6.4 and allowed to stand at 4° C. overnight. The supernatant was centrifuged again (4,000 rpm, 4° C., 10 minutes), and the pH of the resulting supernatant was adjusted to 4.5, followed by further centrifugation (4,000 rpm, 4° C., 10 minutes). The resulting precipitate was recovered to obtain soybean 7S protein. To this soybean 7S protein precipitate was added a 4-fold volume of water, and the mixture was adjusted to pH 6.0. Phytase (Phytase Novo L, manufactured by Novo Industry) was added in a proportion of 0.2% relative to the protein, and the mixture was reacted at 40° C. for 1 hour. After adjusting pH of this reaction mixture to 5.0, a whey fraction was removed by centrifugation (4,000 rpm, 20° C., 10 minutes), and water was added to the resulting precipitate. The mixture was neutralized to pH 7.0, sterilized, and spray-dried to obtain low-phytic acid soybean 7S protein. Low-phytic acid soybean 7S protein thus obtained was subjected to SDS-polyacrylamide gel electrophoresis and measured the degree of staining of stained bands on the gel. As a result, the purity of 7S globulin was 71.2%, and the content of phytic acid was 0.05% relative to the protein. Thus, it was conformed that phytic acid was completely decomposed and removed.

### PRODUCTION EXAMPLE 2

Preparation of Low-Phytic Acid Soybean 7S Protein (2)

Water was added to defatted soybeans in a weight ratio of 1 (soybeans): 10 (water), and the mixture was stirred for 1 hour while the pH was occasionally adjusted to 7.0. The mixture was centrifuged (4,000 rpm, 20° C., 10 minutes), and the supernatant was adjusted to pH to 6.4. Phytase (Phytase Novo L, manufactured by Novo Industry) was added in a proportion of 0.2% relative to the protein, and the mixture was reacted at 40° C. for 1 hour. The reaction mixture was adjusted to pH 6.2 and centrifuged (4,000 rpm, 4° C., 10 minutes), and the pH of the resulting supernatant was adjusted to 5.0, followed by further centrifugation (4,000 rpm, 4° C., 10 minutes). The resulting precipitate was recovered. After addition of water to soybean 7S protein thus obtained, the mixture was neutralized to pH 7.0, sterilized, and spray-dried to obtain low-phytic acid soybean 7S protein. Low-phytic acid soybean 7S protein thus obtained was subjected to SDS-polyacrylamide gel electrophoresis and measured the degree of staining of stained bands on the gel. As a result, the purity of 7S globulin was 78.6%, and the content of phytic acid was 0.05% relative to the protein. Thus, it was conformed that phytic acid was completely decomposed and removed.

### COMPARATIVE PRODUCTION EXAMPLE 1

Preparation of Soybean 7S Protein

After addition of water to soybean 7S protein obtained in Production Example 1, the mixture was neutralized to pH 7.0, sterilized and spray-dried to obtain soybean 7S protein powder. Soybean 7S protein thus obtained was subjected to SDS-polyacrylamide gel electrophoresis and measured the degree of staining. As a result, the purity of 7S globulin was 71.4% and it was confirmed that the protein was sufficient for use in the investigations hereinafter. The content of phytic acid was 1.74% relative to the protein.

### COMPARATIVE PRODUCTION EXAMPLE 2

Preparation of Soybean 11S Protein

The precipitate, which obtained by centrifugation (4,000 rpm, 4° C., 10 minutes) after allowing to stand at 4° C. overnight in Production Example 1, was recovered, and water was added to the precipitate. The mixture was neutralized to pH 7.0, sterilized, and spray-dried to obtain soybean 11S protein. Soybean 11S protein thus obtained was subjected to SDS-polyacrylamide gel electrophoresis. As a result, the purity of 11S globulin was 85.7% and it was confirmed that the protein was sufficient for use in the investigations hereinafter.

### COMPARATIVE PRODUCTION EXAMPLE 3

Preparation of Low-Phytic Acid Soybean 11S Protein

Water was added to the precipitate obtained by allowing to stand at 4° C. overnight followed by centrifugation (4,000 rpm, 4° C., 10 minutes) in Production Example 1, and pH of the mixture was adjusted to 6.0. Phytase (Phytase Novo L, manufactured by Novo Industry) was added in a proportion of 0.2% relative to the protein, and the mixture was reacted at 40° C. for 1 hour. The reaction mixture was neutralized to pH 7.0, sterilized, and spray-dried to obtain low-phytic acid soybean 11S protein. Low-phytic acid soybean 11S protein was subjected to SDS-polyacrylamide gel electrophoresis. As a result, the purity of 11S globulin was 83.9%, and the content of phytic acid was 0.04% relative to the protein. It was confirmed that phytic acid was completely decomposed and removed.

### COMPARATIVE PRODUCTION EXAMPLE 4

Preparation of Conventional Isolated Soybean Protein

The supernatant obtained from defatted soybeans in Production Example 1 was adjusted to pH 4.5, and the resulting precipitate was recovered by centrifugation (4,000 rpm 4° C., 10 minutes). Water was added to the precipitate and the mixture was neutralized to pH 7.0, sterilized and spray-dried to obtain conventional isolated soybean protein.

### EXPERIMENT 1

Solubility Characteristics of Each Fraction and Fraction after Decomposition and Removal of Phytic Acid

A 5% (w/w) sample solution was prepared form each spray-dried product prepared in Production Example 2 and Comparative Production Examples 1 to 4. After adjusting pH of each solution with hydrochloric acid, the proportion of protein in the supernatant obtained by centrifugation at 12,000 rpm for 10 minutes to the total amount of protein was determined.

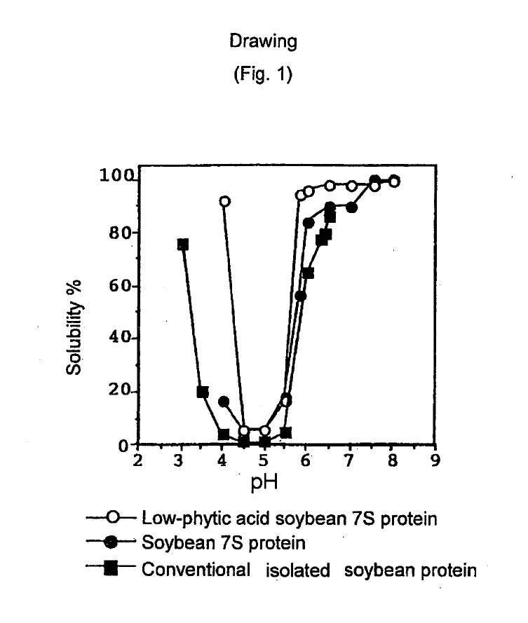

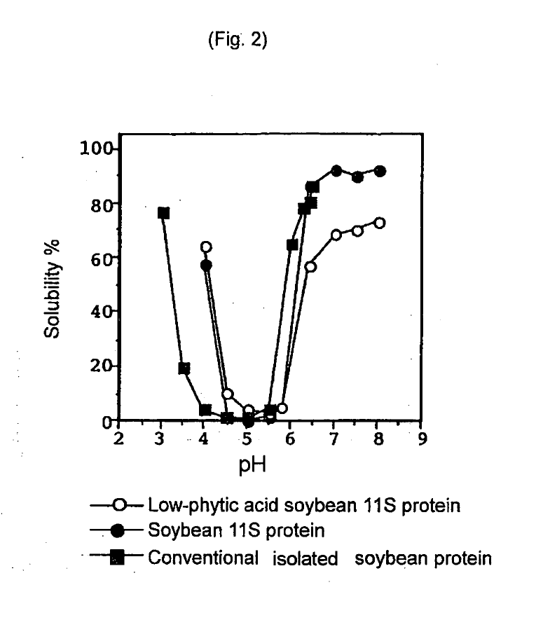

FIG. 1 shows solubility of low-phytic acid soybean 7S protein, solubility of soybean 7S protein and solubility of conventional isolated soybean protein. FIG. 2 shows solubility of low-phytic acid soybean 11S protein, soybean 11S protein and solubility of conventional isolated soybean protein.

As seen from FIGS. 1 and 2, only low-phytic acid soybean 7S protein in which phytic acid is decomposed and removed has largely improved solubility in the vicinity of pH 4.0 that is the pH region utilized in jelly food.

### EXAMPLE 1

Jelly food was prepared using low-phytic acid soybean 7S protein obtained in Production Example 2 according to the formulation shown in Table 1.

After dissolving low-phytic acid soybean 7S protein in water, the solution was homogenized with a high pressure homogenizer (manufactured by APV Co.) at pressure of 150 kg/cm². Fruit juice and an isomerized liquid sugar were added thereto, and the mixture was adjusting to pH 3.6 with a 50% citric acid solution and homogenized with a high pressure homogenizer (manufactured by APV Co.) at pressure of 150 kg/cm². Then, a solution of agar and a gelling agent (trade name GELUP PIS-AS(A), manufactured by Sanei Gen FFI Inc.), which was previously dissolved by heating, and a flavor were added to the homogenate, and the mixture was filled in a container, heated at 90° C. for 20 minutes, and cooled.

The jelly food prepared had a refreshing flavor with less soybean odor. Upon eating, mouthfeel was good with no rough mouthfeel.

TABLE 1
Unit: part

| Raw materials | Example 1 |
|---|---|
| Low-phytic acid soybean 7S protein | 3.0 |
| Isomerized liquid sugar | 20.0 |
| Mango puree | 5.0 |
| Mango essence | 0.2 |
| 50% Citric acid solution | Appropriate amount |
| Water | 40.3 |
| Agar | 0.2 |
| GELUP PIS-AS (A) | 1.3 |
| Water | 30.0 |

### EXAMPLE 2

Jelly food with prepared using low-phytic acid soybean 7S protein obtained in Production Example 1 according the formulation shown in Table 2 was prepared.

Low-phytic acid soybean 7S protein was dissolved in water. After addition of water soluble soybean polysaccharide (trade name SoyaFibe manufactured by Fuji Oil Co. Ltd.) and pectin, the mixture was dissolved and the solution was homogenized with a high pressure homogenizer (manufactured by APV Co.) at pressure of 150 kg/cm².

Fruit juice and isomerized liquid sugar were added to the solution, and the mixture was adjusted to pH 4.1 with a 50% citric acid solution followed by homogenizing with a high pressure homogenizer (manufactured by APV Co.) at pressure of 150 kg/cm². An agar solution, which was previously dissolved by heating, and a flavor were added to the homogenate. The mixture was filled in a container, heated at 90° C. for 20 minutes, and cooled.

Although the jelly food prepared was cloudy, it had a refreshing flavor with less soybean odor. Upon eating, mouthfeel was good with no rough mouthfeel.

TABLE 2
Unit: part

| Raw materials | Example 2 |
|---|---|
| Low-phytic acid soybean 7S protein | 3.0 |
| Isomerized liquid sugar | 20.0 |
| Water-soluble soybean polysaccharide | 0.8 |
| Pectin | 0.2 |
| ⅕ Apple juice | 5.0 |
| Apple flavor | 0.3 |
| 50% Citric acid solution | Appropriate amount |
| Water | 40.2 |
| Agar | 0.5 |
| Water | 30.0 |

### EXAMPLES 3 AND 4

Jelly food was prepared according to the formulation shown in Table 3 by the same preparation process as that in Example 1 using low-phytic acid soybean 7S protein.

TABLE 3
Unit: part

| Raw materials | Example 3 | Example 4 |
|---|---|---|
| Low-phytic acid soybean 7S protein | 5.0 | 8.0 |
| Isomerized liquid sugar | 20.0 | 20.0 |
| Mango puree | 5.0 | 5.0 |
| Mango essence | 0.2 | 0.2 |
| 50% Citric acid solution | Appropriate | Appropriate |
| | amount | amount |
| Water | 39.3 | 46.3 |
| Agar | 0.5 | 0.5 |
| Water | 30.0 | 20.0 |

The jelly food prepared was evaluated. As a result, the texture of Example 4 had somewhat crumbly as compared with the jelly food of Examples 1 to 3, but mouthfeel was good with no rough mouthfeel. Both jelly food in Examples 3 and 4 had a refreshing good flavor with little soybean odor.

### EXAMPLE 5

Drink-type jelly food was prepared using low-phytic acid soybean 7S protein obtained in Production Example according to the formulation shown in Table 4.

Low-phytic acid soybean 7S protein was dissolve din water, to the solution were added water soluble soybean polysaccharide and pectin, and the mixture was dissolved. The resulting solution was homogenized with a high-pressure homogenizer (manufactured by APV Co.) under pressure of 150 kg/cm².

Fruit juice and isomerized liquid sugar were added to the solution, and the mixture was adjusted to pH 3.8 with a 50% citric acid solution, and homogenized with a high-pressure homogenizer (manufactured by APV Co.) under pressure of 150 kg/cm². A solution of a gelling agent (INAGEL DJ-90, manufactured by Ina Food Industry Co., Ltd.), which was previously dissolved by heating, and a flavor were added to the homogenate. The resulting mixture was filled in a cheer-pack type bottle with a straw, heated at 90° C. for 20 minutes, and cooled.

Although the jelly food prepared was cloudy, it had a refreshing good flavor with little soybean odor. Upon eating, mouthfeel was good with no rough mouthfeel.

TABLE 4
Unit: part

| Raw materials | Example 5 |
|---|---|
| Low-phytic acid soybean 7S protein | 3.0 |
| Isomerized liquid sugar | 9.0 |
| Water-soluble soybean polysaccharide | 0.8 |
| Pectin | 0.2 |
| ⅕ Apple juice | 5.0 |
| Apple flavor | 0.3 |
| 50% Citric acid solution | Appropriate amount |
| Water | 54.0 |
| INAGEL DJ-90 | 0.7 |
| Water | 27.0 |

### COMPARATIVE EXAMPLE 1

Jelly food was prepared according to the formulation shown in Table 5.

After dissolving isolated soybean protein powder (trade name FUJIPRO E, manufactured by Fuji Oil Co., Ltd.) in water, the solution was homogenized with a high-pressure homogenizer (manufactured by APV Co.) under pressure of 150 kg/cm². Fruit juice and isomerized liquid sugar were added to the solution, and the mixture was adjusted toe pH 3.8 with a 50% citric acid solution and homogenized with a high-pressure homogenizer (manufactured by APV Co.) under pressure of 150 kg/cm² after. An agar solution, which was previously dissolved by heating, and a flavor were added to the homogenate. The mixture was filled in a container, heated at 90° C. for 20 minutes, and cooled.

The jelly food was evaluated. As a result, a precipitate and coagulation of protein were formed and the jelly food had rough mouthfeel. Further, the jelly food had an odd odor and an odd flavor with poor compatibility with fruit juice, and was hardly edible. Then, it was far from the desired product.

### COMPARATIVE EXAMPLES 2 AND 3

According to the same manner as that in Comparative Example 1, jelly food was obtained except that the protein raw material and the formulation were changed.

The formulation and the results of evaluation of Comparative Examples 1 to 3 are summarized in Table 5.

TABLE 5
Unit: part

| | Comparative | Comparative | Comparative |
|---|---|---|---|
| Raw materials | Example 1 | Example 2 | Example 3 |
| FUJIPRO E | 3.0 | — | — |
| Soybean 7S protein | — | 3.0 | — |
| (Comparative | | | |
| Production Example 1) | | | |
| Low-phytic acid | — | — | 11.0 |
| soybean 7S protein | | | |
| Isomerized liquid | 20.0 | 20.0 | 20.0 |
| sugar | | | |
| Mango puree | 5.0 | 5.0 | 5.0 |
| Mango essence | 0.2 | 0.2 | 0.2 |
| 50% Citric acid | Appropriate | Appropriate | Appropriate |
| solution | amount | amount | amount |
| Water | 41.3 | 41.3 | 48.3 |
| Agar | 0.5 | 0.5 | 0.5 |
| Water | 30.0 | 30.0 | 15.0 |

(Evaluation)

| | | | |
|---|---|---|---|
| Sensory test | Rough | Rough | Very crumbly, |
| | mouthfeel | mouthfeel, | though no rough |
| | bad flavor | bad flavor | mouthfeel, bad |
| Problem | Precipitated | Precipitated | bad workability |
| | before | before | due to high |
| | gelation | gelation | viscosity upon |
| | | | preparation |

### INDUSTRIAL APPLICABILITY

The present inventors has found that low-phytic acid soybean 7S protein obtained by decomposition and removal of phytic acid from fractionated and purified soybean 7S protein, or low-phytic acid soybean 7S protein obtained by treating soybean protein with a phytic acid decomposition enzyme can be utilized as a protein source having high solubility in a weakly acidic region. Then, it is possible to obtain jelly food comprising soybean protein which has high storage stability and hardly forms a precipitate in a weakly acidic region, and is excellent in a flavor, even when it contains soybean protein.

1. Jelly food using low-phytic acid soybean 7S protein.

2. The jelly food comprising soybean 7S protein according to claim 1, wherein the phytic acid content is containing 0.2% or less of phytic acid relative to the protein.

3. The jelly food comprising soybean 7S protein according to claim 1, which is in a weakly acidic region.

4. The jelly food comprising soybean 7S protein according to claim 1, wherein 10% by weight or less of soybean 7S protein is used.

5. The jelly food comprising soybean 7S protein according to claim 2, which is in a weakly acidic region.

6. The jelly food comprising soybean 7S protein according to claim 2, wherein 10% by weight or less of soybean 7S protein is used.

7. The jelly food comprising soybean 7S protein according to claim 3, wherein 10% by weight or less of soybean 7S protein is used.

8. The jelly food comprising soybean 7S protein according to claim 5, wherein 10% by weight or less of soybean 7S protein is used.
